(19) United States
(12) Patent Application Publication
(10) Pub. No.: US 2023/0340675 A1
(43) Pub. Date: Oct. 26, 2023

(54) HYDROGEN DEGASSING USING MEMBRANE

(71) Applicant: HYDROGENICS CORPORATION, Mississauga (CA)

(72) Inventors: Michael A. VALE, Elmira (CA); Michel Leopold Bertrand DISTELMANS, Booischot (BE)

(21) Appl. No.: 18/304,609

(22) Filed: Apr. 21, 2023

Related U.S. Application Data
(60) Provisional application No. 63/334,245, filed on Apr. 25, 2022.

(51) Int. Cl. C25B 1/04; C25B 15/08

(52) U.S. Cl. CPC C25B 1/04; C25B 15/087; C25B 15/083

(57) ABSTRACT

An electrolysis system includes an electrolyzer cell configured to convert water into oxygen gas and hydrogen gas using electrolysis, and a membrane degasser operatively coupled downstream from the electrolyzer cell and configured to receive a water solution output by the electrolyzer cell. The membrane degasser is configured to remove hydrogen gas from the water solution to generate degassed water. The membrane degasser outputs the degassed water to a water tank for recirculation to the electrolyzer cell.

### CROSS-REFERENCE TO RELATED APPLICATIONS

This non-provisional application claims the benefit and priority, under 35 U.S.C. § 119(e) and any other applicable laws or statutes, to U.S. Provisional Patent Application Ser. No. 63/334,245 filed Apr. 25, 2022, the entire disclosure of which is hereby expressly incorporated herein by reference.

### TECHNICAL FIELD

The present disclosure generally relates to an electrolysis system and/or a method of operating an electrolyzer cell.

### BACKGROUND

The electrolysis process produces a solution that includes water saturated with dissolved hydrogen gas. The gas comes out of the solution when the solution leaves a pressurized portion of the electrolyzer. Gas may be removed from the water using a degassing vessel where the water is stored at atmospheric pressure for a period of time.

### SUMMARY

Embodiments of the present invention are included to meet these and other needs.

In one aspect, described herein, an electrolysis system comprises an electrolyzer cell and a membrane degasser. The electrolyzer cell is configured to output a water solution including water and hydrogen gas using electrolysis. The membrane degasser is operatively coupled downstream of the electrolyzer cell. The membrane degasser is configured to receive the water solution output by the electrolyzer cell. The membrane degasser is configured to remove hydrogen gas from the water solution to generate a degassed water and output the degassed water to a water tank for recirculation to the electrolyzer cell.

In some embodiments, the membrane degasser may include a housing enclosing a tube therewithin. In some embodiments, the membrane degasser may include a plurality of membrane members extending along a length of the housing and parallel to the tube. In some embodiments, the plurality of membrane members may be disposed to surround the tube inside of the housing.

In some embodiments, each membrane member of the plurality of membrane members may be a hollow tube. In some embodiments, the hollow tube of each membrane member may be a fiber tube. In some embodiments, the fiber tube may be made of at least one of polypropylene, poly(ether)sulfone, polyvinylidene (di)fluoride, or polyethylene.

In some embodiments, the membrane degasser may include a cartridge sleeve that is disposed within the housing and adjacent to a surface of an inner wall of the housing. In some embodiments, the electrolysis system may further comprise a gas separator tank coupled between the electrolyzer cell and the membrane degasser, wherein the gas separator tank may be configured to receive the water solution output by the electrolyzer cell to remove at least a portion of the hydrogen gas therefrom. In some embodiments, the electrolysis system may further comprise a pump, wherein the pump is operatively coupled between the water tank and the electrolyzer cell to direct water from the water tank to the electrolyzer cell.

According to a second aspect, described herein, a degassing device comprises a housing and a plurality of membrane members. The housing encloses a tube therewithin. The tube extends along a length of the housing and is operatively coupled to output a water solution including water and hydrogen gas. The tube defines a plurality of openings configured to disperse at least a portion of the water solution through the tube and to collect at least a portion of the water solution within an interior of the housing. The plurality of membrane members extend interior to and along the length of the housing and parallel to the tube. The plurality of membrane members are disposed to surround the tube. Each membrane member of the plurality of membrane members is operatively coupled to output a strip gas configured to separate the hydrogen gas within the water solution and remove a separated hydrogen gas from the tube through the plurality of openings to generate a degassed water in the tube.

In some embodiments, the housing may define an inlet liquid port for receiving the water solution therethrough and an outlet liquid port for outputting the degassed water. In some embodiments, a first end of the tube may be operatively coupled to the inlet liquid port and a second end of the tube opposite the first end may be operatively coupled to the outlet liquid port.

In some embodiments, the housing may define an inlet gas port for receiving the strip gas and an outlet gas port for outputting the strip gas and the separated hydrogen gas, wherein the inlet liquid port and the outlet gas port may be disposed about a first end of the housing, and wherein the outlet liquid port and the inlet gas port may be disposed about a second end of the housing opposite the first end of the housing. In some embodiments, a first end of each membrane member of the plurality of membrane members may be coupled to the inlet gas port and a second end opposite the first end of each membrane member of the plurality of membrane members may be coupled to the outlet gas port.

According to a third aspect, described herein, an electrolysis system comprises an electrolyzer cell and a membrane degasser. The electrolyzer cell is configured to convert water into oxygen gas and hydrogen gas using electrolysis. The electrolyzer cell outputs a water solution including water and a liquefied hydrogen gas. The membrane degasser is operatively coupled downstream of the electrolyzer cell to receive the water solution therefrom. The water solution flows through an interior of the membrane degasser in a first direction and a strip gas flows through the interior of the membrane degasser in a second direction. The second direction is opposite the first direction, such that the strip gas separates and removes the liquefied hydrogen gas from the water solution to generate a degassed water. The membrane degasser outputs the degassed water to a water tank for recirculation to the electrolyzer cell.

In some embodiments, the membrane degasser may include a tube and a plurality of elongated membrane members extending parallel to and surrounding the tube, wherein the water solution may flow in the first direction through the tube, and the strip gas may flow in the second direction through the plurality of elongated membrane members. In some embodiments, a gas separator tank may be operatively coupled between the electrolyzer cell and the membrane degasser, wherein the gas separator tank may be configured to receive the water solution output by the electrolyzer cell and remove at least a portion of the liquefied hydrogen gas from the water solution to generate a reduced gas water solution.

In some embodiments, the reduced gas water solution may include less than 1 percent of liquefied hydrogen gas. In some embodiments, the electrolysis system may further comprise a pump, wherein the pump may be operatively coupled between the water tank and the electrolyzer cell to direct water from the water tank to the electrolyzer cell.

### BRIEF DESCRIPTION OF THE DRAWINGS

The detailed description particularly refers to the following figures, in which:

FIG. 1A is perspective view of an electrolyzer cell stack according to the present disclosure;

FIG. 1B is a schematic view of an electrolysis system configured to utilize the electrolyzer cell stack of FIG. 1A;

FIG. 1C is a schematic view of an additional portion of the electrolysis system of FIG. 1B;

FIG. 2 is a block diagram illustrating an exemplary system for operating an electrolysis device;

FIG. 3 is a block diagram illustrating another exemplary system for operating the electrolysis device; and

FIG. 4 is an illustration of an exemplary implementation of a membrane degasser of the exemplary system of FIG. 3.

### DETAILED DESCRIPTION

Electrolysis is an electrochemical reaction to convert water into hydrogen and oxygen using electricity. Accordingly, among other applications, electrolysis may be used for hydrogen gas production. An electrolysis process that uses electricity generated by renewable energy sources produces hydrogen gas with zero greenhouse gas emissions.

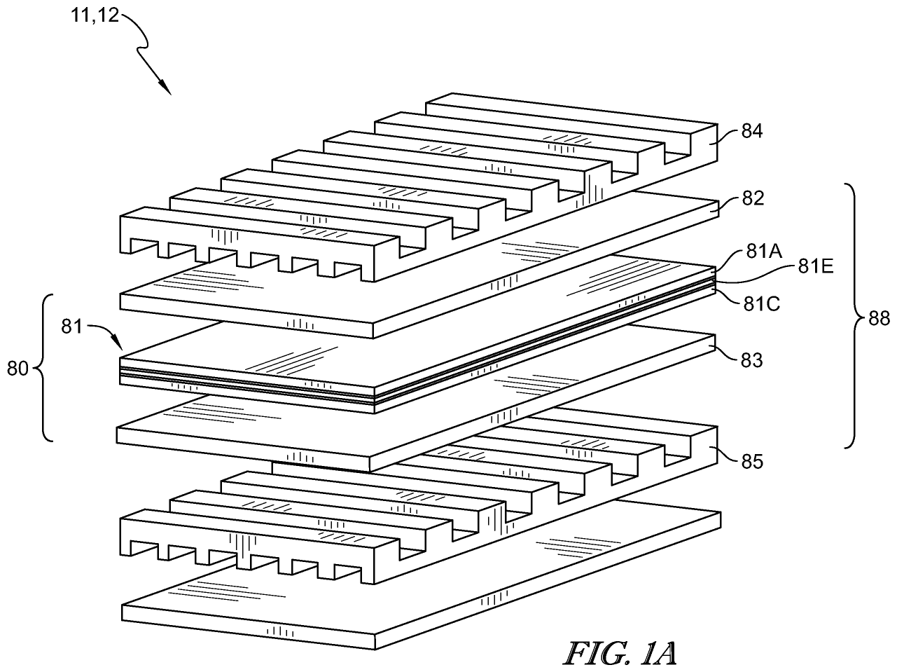

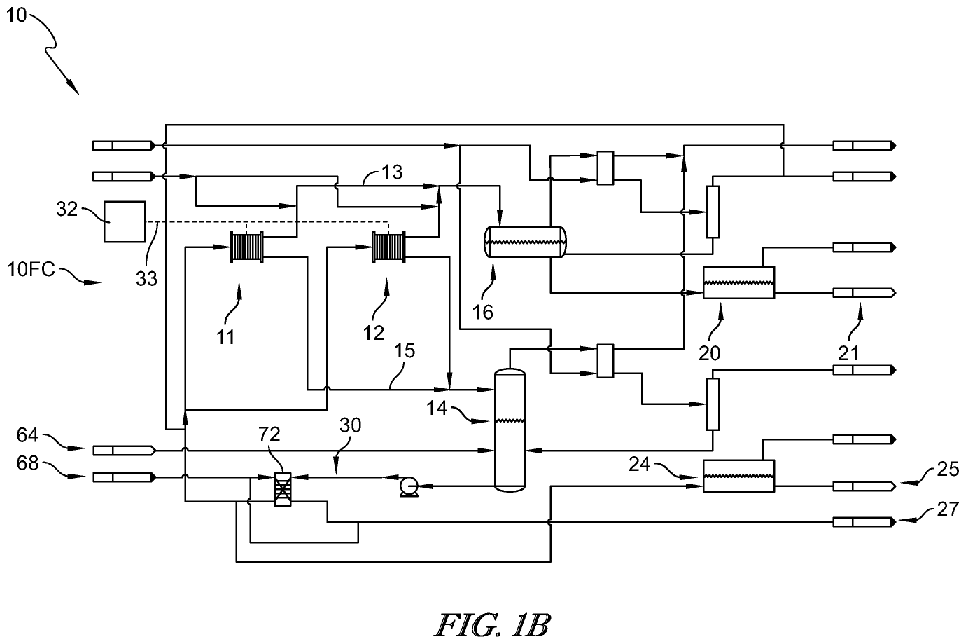

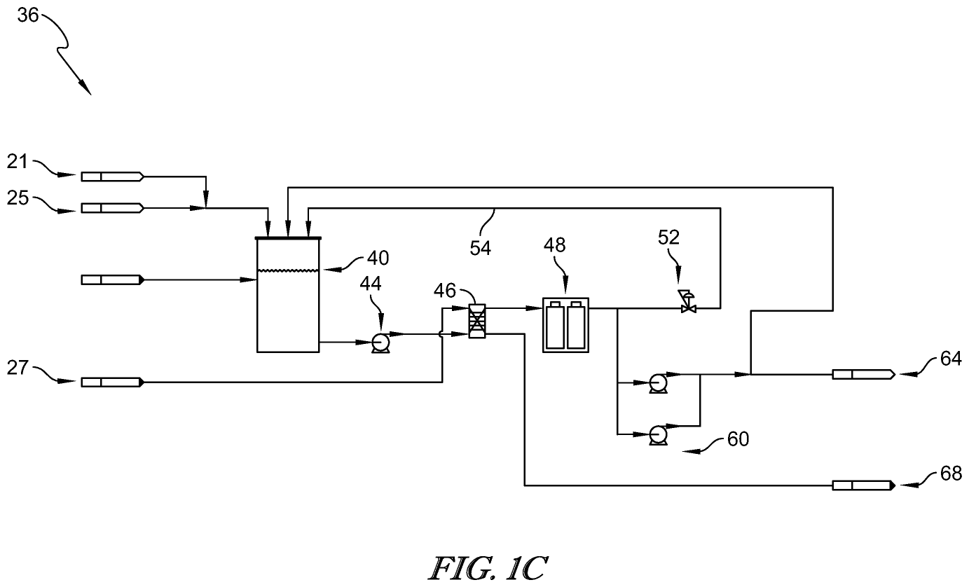

As shown in FIGS. 1A and 1B, an electrolysis system 10 is typically configured to utilize water and electricity to produce hydrogen and oxygen. An electrolysis system 10 typically includes one or more electrolyzer cells 80 that utilize electricity to chemically produce substantially pure hydrogen and oxygen from deionized water. Often the electrical source for the electrolysis system 10 is produced from power or energy generation systems, including renewable energy systems such as wind, solar, hydroelectric, and geothermal sources for the production of green hydrogen. In turn, the pure hydrogen produced by the electrolysis system 10 is often utilized as a fuel or energy source for those same power generation systems, such as fuel cell systems. Alternatively, the pure hydrogen produced by the electrolysis system 10 may be stored for later use.

The typical electrolyzer cell 80, or electrolytic cell 80, is comprised of multiple assemblies compressed and bound into a single assembly, and multiple electrolyzer cells 80 may be stacked relative to each other, along with bipolar plates (BPP) 84, 85 therebetween, to form an electrolyzer cell stack (for example, electrolyzer cell stacks 11, 12 in FIG. 1A). Each electrolyzer cell stack 11, 12 may house a plurality of electrolyzer cells 80 connected together in series and/or in parallel. The number of electrolyzer cell stacks 11, 12 in the electrolysis system 10 can vary depending on the amount of power required to meet the power need of any load (e.g., fuel cell stack). The number of electrolyzer cells 80 in an electrolyzer cell stack 11, 12 can vary depending on the amount of power required to operate the electrolysis system 10 including the electrolyzer cell stack 11, 12.

An electrolyzer cell 80 includes a multi-component membrane electrode assembly (MEA) 81 that has an electrolyte 81E, an anode 81A, and a cathode 81C. Typically, the anode 81A, cathode 81C, and electrolyte 81E of the membrane electrode assembly (MEA) 81 are configured in a multi-layer arrangement that enables the electrochemical reaction to produce hydrogen and/or oxygen via contact of the water with one or more gas diffusion layers 82, 83. The gas diffusion layers (GDL) 82, 83, which may also be referred to as porous transport layers (PTL) 82, 83, are typically located on one or both sides of the MEA 81. Bipolar plates (BPP) 84, 85 often reside on either side of the GDLs 82, 83 and separate the individual electrolyzer cells 80 of the electrolyzer cell stack 11, 12 from one another. One bipolar plate 85, the adjacent gas diffusion layers 82, 83, and the MEA 81 can form a repeating unit 88.

As shown in FIGS. 1B and 1C, an exemplary electrolysis system 10 can include two electrolyzer cell stacks 11, 12 and a fluidic circuit 10FC including the various fluidic pathways shown in FIGS. 1B and 1C that is configured to circulate, inject, and purge fluid and other components to and from the electrolysis system 10. A person skilled in the art would understand that one or a variety of a number of components within the fluidic circuit 10FC, as well as more or less than two electrolyzer cell stacks 11, 12, may be utilized in the electrolysis system 10. For example, the electrolysis system 10 may include one electrolyzer cell stack 11, and in other examples, the electrolysis system 10 may include three or more electrolyzer cell stacks 11.

The electrolysis system 10 may include one or more types of electrolyzer cell stacks 11, 12 therein. In the illustrated embodiment, a polymer electrolyte membrane (PEM) electrolyzer cell 80 may be utilized in the stacks 11, 12. A PEM electrolyzer cell 80 typically operates at about 4° C. to about 150° C., including any specific or range of temperatures comprised therein. A PEM electrolyzer cell 80 also typically functions at about 100 bar or less, but can go up to about 1000 bar (including any specific or range of pressures comprised therein), which reduces the total energy demand of the system 10. A standard electrochemical reaction that occurs in a PEM electrolyzer cell 80 to produce hydrogen is as follows.

Anode: 2H₂O→O₂+4H⁺+4e⁻

Cathode: 4H+⁺4e→2H₂

Overall: 2H₂O (liquid)→2H₂+O₂

Additionally, a solid oxide electrolyzer cell 80 may be utilized in the electrolysis system 10. A solid oxide electrolyzer cell 80 will function at about 500° C. to about 1000° C., including any specific or range of temperatures comprised therein. A standard electrochemical reaction that occurs in a solid oxide electrolyzer cell 80 to produce hydrogen is as follows.

Anode: 2O²⁻→O₂+4e⁻

Cathode: 2H₂O→4e⁻+2H₂+2O²⁻

Overall: 2H₂O (liquid)→2H₂+O₂

Moreover, an AEM electrolyzer cell 80 may utilized, which uses an alkaline media. An exemplary AEM electrolyzer cell 80 is an alkaline electrolyzer cell 80. Alkaline electrolyzer cells 80 comprise aqueous solutions, such as potassium hydroxide (KOH) and/or sodium hydroxide (NaOH), as the electrolyte. Alkaline electrolyzer cells 80 typically perform at operating temperatures ranging from about 0° C. to about 150° C., including any specific or range of temperatures comprised therein. Alkaline electrolyzer cells 80 generally operate at pressures ranging from about 1 bar to about 100 bar, including any specific or range of pressures comprised therein. A typical hydrogen-generating electrochemical reaction that occurs in an alkaline electrolyzer cell 80 is as follows.

Anode: 4OH⁻→O₂+2H₂O+4e⁻

Cathode: 4H₂O+4e⁻→2H₂+4OH⁻

Overall: 2 H₂O→2H₂+O₂

As shown in FIG. 1B, the electrolyzer cell stacks 11, 12 include one or more electrolyzer cells 80 that utilize electricity to chemically produce substantially pure hydrogen and oxygen from water. In turn, the pure hydrogen produced by the electrolyzer may be utilized as a fuel or energy source. As shown in FIG. 1B, the electrolyzer cell stack 11, 12 outputs the produced hydrogen along a fluidic connecting line 13 to a hydrogen separator 16, and also outputs the produced oxygen along a fluidic connecting line 15 to an oxygen separator 14.

The hydrogen separator 16 may be configured to output pure hydrogen gas and also send additional output fluid to a hydrogen drain tank 20, which then outputs fluid to a deionized water drain 21. The oxygen separator 14 may output fluid to an oxygen drain tank 24, which in turn outputs fluid to a deionized water drain 25. A person skilled in the art would understand that certain inputs and outputs of fluid may be pure water or other fluids such as coolant or byproducts of the chemical reactions of the electrolyzer cell stacks 11, 12. For example, oxygen and hydrogen may flow away from the cell stacks 11, 12 to the respective separators 14, 16. The system 10 may further include a rectifier 32 configured to convert electricity 33 flowing to the cell stacks 11, 12 from alternating current (AC) to direct current (DC).

The deionized water drains 21, 25 each output to a deionized water tank 40, which is part of a polishing loop 36 of the fluidic circuit 10FC, as shown in FIG. 1C. Water with ion content can damage electrolyzer cell stacks 11, 12 when the ionized water interacts with internal components of the electrolyzer cell stacks 11, 12. The polishing loop 36, shown in greater detail in FIG. 1C, is configured to deionize the water such that it may be utilized in the cell stacks 11, 12 and not damage the cell stacks 11, 12.

In the illustrated embodiment, the deionized water tank 40 outputs fluid, in particular water, to a deionized water polishing pump 44. The deionized water polishing pump 44 in turn outputs the water to a water polishing heat exchanger 46 for polishing and treatment. The water then flows to a deionized water resin tank 48.

Coolant is directed through the electrolysis system 10, in particular through a deionized water heat exchanger 72 that is fluidically connected to the oxygen separator 14. The coolant used to cool said water may also be subsequently fed to the water polishing heat exchanger 46 via a coolant input 27 for polishing. The coolant is then output back to the deionized water heat exchanger 72 for cooling the water therein.

After the water is output from the water polishing heat exchanger 46 and subsequently to the deionized water resin tank 48, a portion of the water may be fed to deionized water high pressure feed pumps 60. Another portion of the water may be fed to a deionized water pressure control valve 52, as shown in FIG. 1C. The portion of the water that is fed to the deionized water pressure control valve 52 flows through a recirculation fluidic connection 54 that allows the water to flow back to the deionized water tank 40 for continued polishing.

In some embodiments, the electrolysis system 10 may increase deionized water skid for polishing water flow to flush out ions within the water at a faster rate. The portion of the water that is fed to the deionized water high pressure feed pumps 60 is then output to a deionized water feed 64, which then flows into the oxygen separator 14 for recirculation and eventual reuse in the electrolyzer cell stacks 11, 12. This process may then continuously repeat.

The electrolysis system 10 described herein, may be used in a stationary and/or immovable power system, such as industrial applications and power generation plants. The electrolysis system 10 may also be implemented in conjunction with other electrolysis systems 10.

The present electrolysis system 10 may be comprised in stationary or mobile applications. The electrolysis system 10 may be in a vehicle or a powertrain 100. A vehicle or powertrain 100 comprising the electrolysis system 10 may be an automobile, a pass car, a bus, a truck, a train, a locomotive, an aircraft, a light duty vehicle, a medium duty vehicle, or a heavy duty vehicle.

In addition, it may be appreciated by a person of ordinary skill in the art that the electrolysis system 10, electrolyzer stack 11, 12, and/or the electrolyzer cell 80 described in the present disclosure may be substituted for any electrochemical system, such as a fuel cell system, a fuel cell stack, and/or a fuel cell (FC), respectively. As such, in some embodiments, the features and aspects described and taught in the present disclosure regarding electrolysis system 10, electrolyzer stack 11, 12, and/or the electrolyzer cell 80 also relate a fuel cell system, a fuel cell stack, and/or a fuel cell (FC), respectively. In further embodiments, the features and aspects described or taught in the present disclosure do not relate, and are therefore distinguishable from, those of a fuel cell system, a fuel cell stack, and/or a fuel cell (FC).

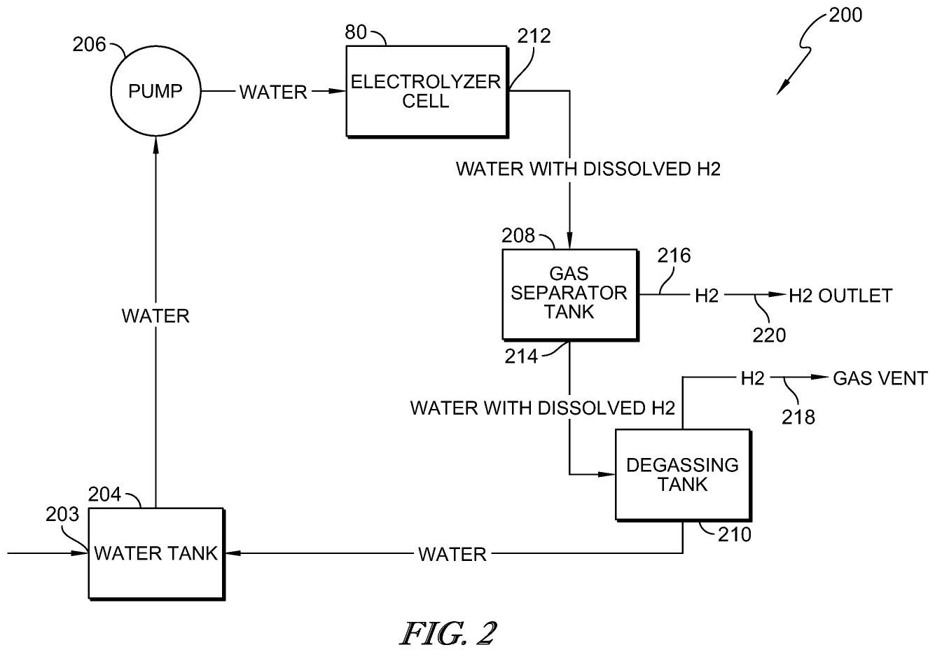

Another example of an electrolysis system 200, similar to electrolysis system 10, is shown in FIG. 2. Electrolysis system 200 includes one or more pumps, vents, storage tanks, power supplies, separators, and/or other components. For instance, the electrolysis system 200 for operating the electrolyzer cell 80 illustrated in FIG. 2 includes a water tank 204, a pump 206, a gas separator tank 208, and/or a degassing tank 210. The pump 206 is operatively coupled to transfer water from the water tank 204 to the electrolyzer cell 80. The water tank 204 receives water from a water inlet 203 that may or may not be directly or indirectly connected and/or associated with a water source (not shown).

The electrolyzer cell 80 may produce and output a water solution, e.g., water saturated with dissolved liquefied hydrogen gas. In one example, the hydrogen gas is released by the water solution when the solution leaves a pressurized portion of the electrolyzer cell 80. Accordingly, an output 212 of the electrolyzer cell 80 is operatively coupled to the gas separator tank 208. The gas separator tank 208 may be configured to output 216 at least a portion of the dissolved hydrogen gas comprised by the water solution that is output by the electrolyzer cell 80 through a hydrogen outlet 220 that opens to the atmosphere and/or environment (see FIG. 2).

To continue removal of the dissolved hydrogen gas from the water solution, an output 214 of the gas separator tank 208 may be coupled to the degassing tank 210. The degassing tank 210 may be configured to store the water at atmospheric pressure for a predefined period of time and vent the remaining dissolved hydrogen gas removed from the water solution through a degassing tank vent 218. Thus, the gas separator tank 208 outputs at least a portion of the dissolved hydrogen gas from the water solution through the hydrogen outlet 220, and the degassing tank 210 outputs the remaining dissolved hydrogen gas through the degassing tank vent 218. While sufficiently effective in small-scale applications, the degassing tank 210 may be inefficient in large-scale industrial applications of electrolyzer cells 80. In particular, as the amount of the dissolved hydrogen gas that needs to be removed from the water solution downstream from the gas separator tank 208 increases, the size, and, therefore the cost of the degassing tank 210 also increases, sometimes to cost-prohibitive and/or financially impractical or improbable levels, particularly for some organizations or industries.

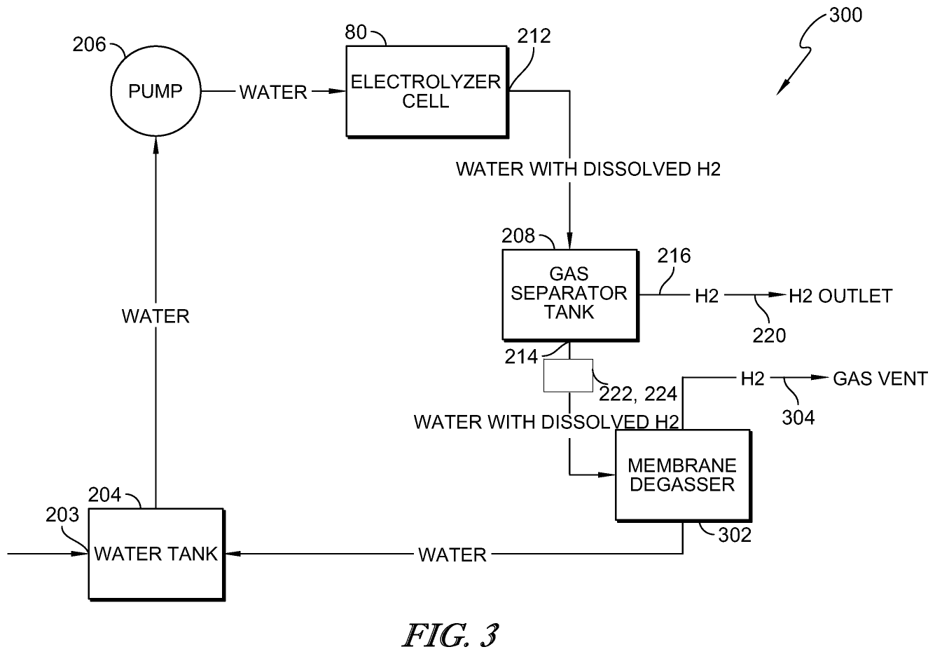

FIG. 3 illustrates another exemplary electrolysis system 300, similar to electrolysis system 200, for operating the electrolyzer cell 80 in accordance with the present disclosure. For the sake of clarity and consistency, components of the electrolysis system 300 that correspond to those of the electrolysis system 200 as illustrated and described in reference to FIG. 2 will not be discussed anew. It should be noted, however, that the electrolysis system 300 embodiment utilizes a membrane degasser 302 instead of the degassing tank 210 as described in detail for the electrolysis system 200 embodiment.

As shown in FIG. 3, the membrane degasser 302 may be configured to remove the hydrogen gas from the water solution 446. The membrane degasser 302 also routes the separated hydrogen gas for safe removal. Safe removal of the hydrogen gas may include, for example, using a membrane degasser vent 304 or usage of the hydrogen gas as a fuel in a burner, a fuel cell, and/or another application.

Referring back to FIG. 3, the membrane degasser 302 is operatively coupled downstream from the electrolyzer cell 80 and configured to receive a water solution 446 that is output (e.g. comprising a dissolved hydrogen gas and water) by the electrolyzer cell 80. For example, the membrane degasser 302 may be positioned between and/or connected to one or more the gas separator tank 208 and the water tank 204, as shown in FIG. 3. The membrane degasser 302 is configured to remove dissolved hydrogen gas from the water solution 446 to generate water 448 (e.g., pure or substantially pure water). The water 448 generated by the membrane degasser 302 is a degassed water 448. The degassed water 448 is output to the water tank 204 for recirculation to the electrolyzer cell 80.

The gas separator tank 208 receives the water solution output by the electrolyzer cell 80 and removes at least a portion of the hydrogen gas from the water solution to generate a reduced gas water solution 446. The reduced gas water solution 446 includes less than 1 percent of hydrogen gas. The reduced gas water solution 446 then enters the membrane degasser 302, where the remaining hydrogen gas is removed.

The membrane degasser 302 is further configured to output water 448 to the water tank 204 for recirculation to the electrolyzer cell 80. Unlike the degassing tank 210 of the electrolysis system 200, the membrane degasser 302 provides a much more compact setup and increases an amount of hydrogen gas that may be removed within a predefined period of time from the water solution 446. The incorporation of the membrane degasser 302, in turn, lowers the cost of hydrogen gas removal from the water solution 446 as compared to the costs associated with using the degassing tank 210. Still further, the membrane degasser 302 is configured to remove the same amount of hydrogen gas in a smaller period of time than the degassing tank 210, thus typically making use of the membrane degasser 302 faster to remove hydrogen gas than use of the degassing tank 210.

For example, the degassing tank 210 may require a holding time of the water solution 446 within the degassing tank 210. The holding time required by the degassing tank 210 causes the electrolysis system 200 to process a lesser amount of the water solution 446 than the electrolysis system 300 including the membrane degasser 302. Specifically, the holding time for the degassing tank 210 may range from about 1 minute to about 10 minutes more than the time required for the membrane degasser 302 to process the same amount of the water solution 446, including any specific range or amount of time comprised therein. Therefore, the holding time may equate to the electrolysis system 200 having the degassing tank 210 processing about 1,000 L to about 10,000 L less of the water solution 446 than the electrolysis system 300 comprising the membrane degasser 302, including any specific range or amount of water solution 446 comprised therein.

Illustratively, the holding time for the degassing tank 210 may be about 4 minutes more or longer than the time required to process the water solution 446 by the membrane degasser 302. In such an embodiment, the holding time may equate to the electrolysis system 200 having the degassing tank 210 processing about 4,000 L less of the water solution 446 than the electrolysis system 300 comprising the membrane degasser 302. As such, the electrolysis system 300 comprising the membrane degasser 302 may have advantages in being less costly and/or requiring less time than the electrolysis system 200 having the degassing tank 210.

In one example, the membrane degasser 302 is operatively coupled at the output 214 of the gas separator tank 208 to receive the water solution 446 therefrom. In an example, an amount of hydrogen gas separated and, thus, removed by the gas separator tank 208 may be about 90% to about 99%, including any specific or range of percentage comprised therein. As another example, the membrane degasser 302 may be configured to separate about 1% to about 10%, including any specific or range of percentage comprised therein, of the hydrogen gas from the water solution 446 output by the gas separator tank 208.

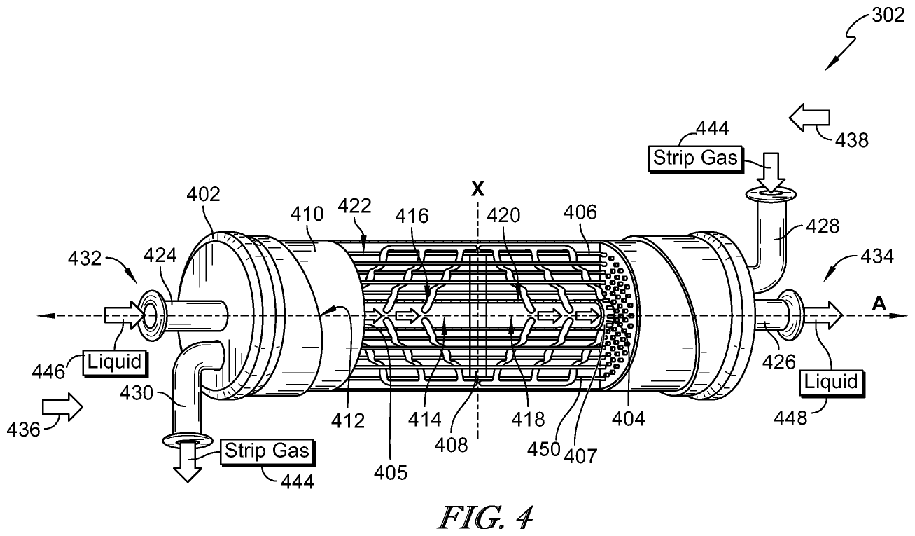

As described in reference to at least FIG. 4, the water solution 446 may flow as a liquid 446 through an interior of the membrane degasser 302 in a first direction 436. A strip gas 444 may enter and flow through the interior of the membrane degasser 302 in a second direction 438. The second direction 438 is opposite the first direction 436, such that the strip gas 444 removes separated hydrogen gas from the opposite direction that the water solution 446 is flowing in order to generate a degassed water 448.

An example strip gas 444 may be an inert gas, such as, but not limited to, nitrogen. In some instances, such as when the hydrogen gas is separated by the membrane degasser 302, that hydrogen gas may be reused as fuel (e.g., in fuel cells). Therefore contamination of the hydrogen gas by a strip gas 444 (e.g. nitrogen) may not be ideal. In such implementations, the electrolysis system 300 may also include a vacuum pump 224 configured to separate the hydrogen gas from the water solution 446 received from the gas separator tank 208 without the use of an inert or strip gas 444, thereby avoiding contamination of the removed hydrogen gas for use in further applications.

Referring back to FIG. 3, the membrane degasser 302 may be configured to route the removed hydrogen gas for safe venting, storage, and/or subsequent usage in fuel cells and other applications through the membrane degasser vent 304. The membrane degasser 302 may be operatively coupled to output the degassed water 448 to the water tank 204 for recirculation to the electrolyzer cell 80, such as, for example, by the pump 206. The membrane degasser 302 may also be configured to remove oxygen gas from the water solution 446 as opposed to hydrogen gas.

FIG. 4 illustrates an exemplary embodiment of the membrane degasser 302 device. The membrane degasser 302 includes a housing 402, a tube 404, and a plurality of membrane members 406. The housing 402 is configured to enclose the tube 404 therewithin. In one example, the tube 404 extends along a length of the housing 402 and is operatively coupled to receive, transfer, and/or output the water solution 446.

The housing 402 defines an inlet liquid port 424 for receiving the water solution 446 therethrough and an outlet liquid port 426 for outputting water 448. Thus, a first end 405 of the tube 404 is operatively coupled to the inlet liquid port 424. A second end 407 of the tube 404 is operatively coupled to the outlet liquid port 426. In another example, the housing 402 defines an inlet gas port 428 for receiving gas 444 and an outlet gas port 430 for outputting gas 444.

The inlet liquid port 424 and the outlet gas port 430 are disposed about a first end 432 of the housing 402. The outlet liquid port 426 and the inlet gas port 428 are disposed about a second end 434 of the housing 402. Accordingly, the water solution 446 flows through the tube 404 in the first direction 436 from the inlet liquid port 424 to the outlet liquid port 426.

The strip gas 444 flows through the plurality of elongated membrane members 406 within the membrane degasser 302. The strip gas 444 also flows in the second direction 438 from the inlet gas port 428 to the outlet gas port 430. The second direction 438 is opposite the first direction 436, such that the hydrogen gas and the liquid water solution 446 flow in reverse and/or opposite directions within the membrane degasser 302.

The plurality of membrane members 406 extend along the length of the housing 402 and are positioned in parallel to and outside of the tube 404. In an example, the membrane members 406 are interwoven into a weblike arrangement. The membrane members 406 may also be disposed to surround and/or envelop the tube 404 within the housing 402. In some instances, each membrane member 406 is operatively coupled to receive, transfer, and/or output strip gas 444.

In one example, the membrane degasser 302 includes a baffle 408. The baffle 408 extends along a center axis X of the housing 402 and perpendicular to the tube 404. The baffle 408 also extends in an opposite direction through the plurality of membrane members 406 within the housing 402.

The plurality of membrane members 406 remove gas from the water solution 446 output by the gas separator tank 208. Each membrane member 406 may be a hollow fiber extending parallel to a center longitudinal axis A extending along the length of the housing 402. In one example, the membrane members 406 may be entangled into an array and/or wrapped around the tube 404 inside the housing 402. In some instances, the membrane members 406 may be hollow tubes. In some instances, the membrane members 406 formed as hollow tubes may be fiber tubes. In some instances, the membrane members 406 may be made of a material (e.g., a fibrous material), such as, but not limited to, polypropylene, poly(ether)sulfone, polyvinylidene (di)fluoride, and/or polyethylene.

As shown in FIG. 3, the system 300 may include a cooler 222 operatively coupled at the output 214 of the gas separator tank 208. The cooler 222 is configured to lower a temperature of the water solution 446 prior to the water solution 446 entering the membrane degasser 302. When the temperature of the water solution 446 supplied to the membrane degasser 302 is lowered to a predefined threshold temperature, then thermoplastic polymer materials may be used as the fibrous material of the membrane members 406. The predefined threshold temperature may range from about 30° C. to about 70° C., including any specific or range of temperatures comprised therein.

Referring back to FIG. 4, in one example, the tube 404 includes a first portion 414 defining a plurality of distribution openings 416. The tube 404 also includes a second portion 418 defining a plurality of collection openings 420. The plurality of distribution openings 416 disperse at least a portion of the water solution 446 being transferred through the tube 404 out of the tube 404 and to the membrane members 406. The plurality of collection openings 420 collect at least a portion of the water solution 446 within the housing 402.

During operation, the water solution 446 flows over the membrane members 406 and, a strip gas 444 flow within (e.g., interior to) the membrane members 406. Material of the membrane members 406 may repel water, such that the membrane members 406 may be hydrophobic. Accordingly, the strip gas 444 flowing within the membrane members 406 and the water solution 446 flowing exterior to the membrane members 406 may be in direct contact with one another without the strip gas 444 dispersing within the water solution 446.

A body 422 of each membrane member 406 may define a plurality of pores 450. Dissolved hydrogen gas within the water solution 446 may be separated from the water and may enter the membrane member 406 by moving through the plurality of pores 450 of the membrane member 406. The dissolved and separated hydrogen gas may then be carried away with the strip gas 444 flowing within the membrane member 406. With the removal of the dissolved hydrogen gas, the tube 404 then contains the degassed water 448.

In one example, a first pressure applied to a flow of the water solution 446 in the first direction 436 may be greater than a second pressure applied to a flow of the strip gas 444 in the second direction 438. The pressure difference generates the driving force for the dissolved hydrogen gas. The pressure difference also drives hydrogen to become separated from the water in the water solution 446 and pass through the plurality of pores 450 of the membrane members 406.

As an example, the water 448 exiting the membrane degasser 302 may be at about atmospheric pressure. Accordingly, the pressure applied to the flow of the strip gas 444 (or, alternatively, the vacuum, where a vacuum pump 224 is being used instead of the strip gas 444) may be such that a partial pressure of the hydrogen on the gas side is sufficiently low to ensure a good extraction of hydrogen from the water solution 446. For example, the strip gas 444 may be an inert gas operating at just above atmospheric pressure (i.e., an amount of pressure sufficient to overcome a pressure drop that will occur within the membrane members 406). As another example, the pressure of the vacuum may be about 1/10th of atmospheric pressure.

The membrane degasser 302 includes a cartridge sleeve 410. The cartridge sleeve 410 may be disposed within the housing 402 and adjacent to a surface of an inner wall 412 of the housing 402. The cartridge sleeve 410 may extend the length of the housing 402, such as from the first end 432 to the second end 434.

In addition to removing hydrogen from the water solution 446, the membrane degasser 302 described in reference to at least FIGS. 3 and 4 may provide an efficient, compact, and/or maintenance-free technology to also remove carbon dioxide, and/or oxygen from water without any chemical treatment. Removal of carbon dioxide and oxygen via a membrane degasser 302 may prevent corrosion on boilers and piping to protect capital investment, extend life time of equipment, and/or reduce operating costs. Removing these gases (hydrogen, carbon dioxide, and/or oxygen) may also improve the electrolysis process efficiency of the present systems 200, 300 so as to provide pure or substantially pure water and pure or substantially pure hydrogen gas that may be further utilized in downstream, subsequent, and/or recycled applications.

The following described aspects of the present invention are contemplated and non-limiting:

A first aspect of the present invention relates to an electrolysis system. The electrolysis system comprises an electrolyzer cell and a membrane degasser. The electrolyzer cell is configured to output a water solution including water and hydrogen gas using electrolysis. The membrane degasser is operatively coupled downstream of the electrolyzer cell. The membrane degasser is configured to receive the water solution output by the electrolyzer cell. The membrane degasser is configured to remove hydrogen gas from the water solution to generate a degassed water and output the degassed water to a water tank for recirculation to the electrolyzer cell.

A second aspect of the present invention relates to a degassing device. The degassing device comprises a housing and a plurality of membrane members. The housing encloses a tube therewithin. The tube extends along a length of the housing and is operatively coupled to output a water solution including water and hydrogen gas. The tube defines a plurality of openings configured to disperse at least a portion of the water solution through the tube and to collect at least a portion of the water solution within an interior of the housing. The plurality of membrane members extend interior to and along the length of the housing and parallel to the tube. The plurality of membrane members are disposed to surround the tube. Each membrane member of the plurality of membrane members is operatively coupled to output a strip gas configured to separate the hydrogen gas within the water solution and remove a separated hydrogen gas from the tube through the plurality of openings to generate a degassed water in the tube.

A third aspect of the present invention relates to an electrolysis system. The electrolysis system comprises an electrolyzer cell and a membrane degasser. The electrolyzer cell is configured to convert water into oxygen gas and hydrogen gas using electrolysis. The electrolyzer cell outputs a water solution including water and a liquefied hydrogen gas. The membrane degasser is operatively coupled downstream of the electrolyzer cell to receive the water solution therefrom. The water solution flows through an interior of the membrane degasser in a first direction and a strip gas flows through the interior of the membrane degasser in a second direction. The second direction is opposite the first direction, such that the strip gas separates and removes the liquefied hydrogen gas from the water solution to generate a degassed water. The membrane degasser outputs the degassed water to a water tank for recirculation to the electrolyzer cell.

In the first aspect of the present invention, the membrane degasser may include a housing enclosing a tube therewithin. In the first aspect of the present invention, the membrane degasser may include a plurality of membrane members extending along a length of the housing and parallel to the tube. In the first aspect of the present invention, the plurality of membrane members may be disposed to surround the tube inside of the housing.

In the first aspect of the present invention, each membrane member of the plurality of membrane members may be a hollow tube. In the first aspect of the present invention, the hollow tube of each membrane member may be a fiber tube. In the first aspect of the present invention, the fiber tube may be made of at least one of polypropylene, poly(ether)sulfone, polyvinylidene (di)fluoride, or polyethylene.

In the first aspect of the present invention, the membrane degasser may include a cartridge sleeve that is disposed within the housing and adjacent to a surface of an inner wall of the housing. In the first aspect of the present invention, the electrolysis system may further comprise a gas separator tank coupled between the electrolyzer cell and the membrane degasser, wherein the gas separator tank may be configured to receive the water solution output by the electrolyzer cell to remove at least a portion of the hydrogen gas therefrom. In the first aspect of the present invention, the electrolysis system may further comprise a pump, wherein the pump may be operatively coupled between the water tank and the electrolyzer cell to direct water from the water tank to the electrolyzer cell.

In the second aspect of the present invention, the housing may define an inlet liquid port for receiving the water solution therethrough and an outlet liquid port for outputting the degassed water. In the second aspect of the present invention, a first end of the tube may be operatively coupled to the inlet liquid port and a second end of the tube opposite the first end may be operatively coupled to the outlet liquid port.

In the second aspect of the present invention, the housing may define an inlet gas port for receiving the strip gas and an outlet gas port for outputting the strip gas and the separated hydrogen gas, wherein the inlet liquid port and the outlet gas port may be disposed about a first end of the housing, and wherein the outlet liquid port and the inlet gas port may be disposed about a second end of the housing opposite the first end of the housing. In the second aspect of the present invention, a first end of each membrane member of the plurality of membrane members may be coupled to the inlet gas port and a second end opposite the first end of each membrane member of the plurality of membrane members may be coupled to the outlet gas port.

In the third aspect of the present invention, the membrane degasser may include a tube and a plurality of elongated membrane members extending parallel to and surrounding the tube, wherein the water solution may flow in the first direction through the tube and the strip gas may flow in the second direction through the plurality of elongated membrane members. In the third aspect of the present invention, a gas separator tank may be operatively coupled between the electrolyzer cell and the membrane degasser, wherein the gas separator tank may be configured to receive the water solution output by the electrolyzer cell and remove at least a portion of the liquefied hydrogen gas from the water solution to generate a reduced gas water solution.

In the third aspect of the present invention, the reduced gas water solution may include less than 1 percent of liquefied hydrogen gas. In the third aspect of the present invention, the electrolysis system may further comprise a pump, wherein the pump may be operatively coupled between the water tank and the electrolyzer cell to direct water from the water tank to the electrolyzer cell.

The features illustrated or described in connection with one exemplary embodiment may be combined with any other feature or element of any other embodiment described herein. Such modifications and variations are intended to be included within the scope of the present disclosure. Further, a person skilled in the art will recognize that terms commonly known to those skilled in the art may be used interchangeably herein.

The above embodiments are described in sufficient detail to enable those skilled in the art to practice what is claimed and it is to be understood that logical, mechanical, and electrical changes may be made without departing from the spirit and scope of the claims. The detailed description is, therefore, not to be taken in a limiting sense.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Specified numerical ranges of units, measurements, and/or values comprise, consist essentially or, or consist of all the numerical values, units, measurements, and/or ranges including or within those ranges and/or endpoints, whether those numerical values, units, measurements, and/or ranges are explicitly specified in the present disclosure or not.

Unless defined otherwise, technical and scientific terms used herein have the same meaning as is commonly understood by one of ordinary skill in the art to which this disclosure belongs. The terms “first,” “second,” “third” and the like, as used herein do not denote any order or importance, but rather are used to distinguish one element from another. The term “or” is meant to be inclusive and mean either or all of the listed items. In addition, the terms “connected” and “coupled” are not restricted to physical or mechanical connections or couplings, and can include electrical connections or couplings, whether direct or indirect.

Moreover, unless explicitly stated to the contrary, embodiments “comprising,” “including,” or “having” an element or a plurality of elements having a particular property may include additional such elements not having that property. The term “comprising” or “comprises” refers to a composition, compound, formulation, or method that is inclusive and does not exclude additional elements, components, and/or method steps. The term “comprising” also refers to a composition, compound, formulation, or method embodiment of the present disclosure that is inclusive and does not exclude additional elements, components, or method steps.

The phrase “consisting of” or “consists of” refers to a compound, composition, formulation, or method that excludes the presence of any additional elements, components, or method steps. The term “consisting of” also refers to a compound, composition, formulation, or method of the present disclosure that excludes the presence of any additional elements, components, or method steps.

The phrase “consisting essentially of” or “consists essentially of” refers to a composition, compound, formulation, or method that is inclusive of additional elements, components, or method steps that do not materially affect the characteristic(s) of the composition, compound, formulation, or method. The phrase “consisting essentially of” also refers to a composition, compound, formulation, or method of the present disclosure that is inclusive of additional elements, components, or method steps that do not materially affect the characteristic(s) of the composition, compound, formulation, or method steps.

Approximating language, as used herein throughout the specification and claims, may be applied to modify any quantitative representation that could permissibly vary without resulting in a change in the basic function to which it is related. Accordingly, a value modified by a term or terms, such as “about,” and “substantially” is not to be limited to the precise value specified. In some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

It is to be understood that the above description is intended to be illustrative, and not restrictive. For example, the above-described embodiments (and/or aspects thereof) may be used individually, together, or in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. An electrolysis system comprising:
an electrolyzer cell configured to output a water solution including water and hydrogen gas using electrolysis; and
a membrane degasser operatively coupled downstream of the electrolyzer cell and configured to receive the water solution output by the electrolyzer cell,
wherein the membrane degasser is configured to remove hydrogen gas from the water solution to generate a degassed water and output the degassed water to a water tank for recirculation to the electrolyzer cell.

2. The electrolysis system of claim 1, wherein the membrane degasser includes a housing enclosing a tube therewithin.

3. The electrolysis system of claim 2, wherein the membrane degasser includes a plurality of membrane members extending along a length of the housing and parallel to the tube.

4. The electrolysis system of claim 3, wherein the plurality of membrane members are disposed to surround the tube inside of the housing.

5. The electrolysis system of claim 4, wherein each membrane member of the plurality of membrane members is a hollow tube.

6. The electrolysis system of claim 5, wherein the hollow tube of each membrane member is a fiber tube.

7. The electrolysis system of claim 6, wherein the fiber tube is made of at least one of polypropylene, poly(ether)sulfone, polyvinylidene (di)fluoride, or polyethylene.

8. The electrolysis system of claim 2, wherein the membrane degasser includes a cartridge sleeve that is disposed within the housing and adjacent to a surface of an inner wall of the housing.

9. The electrolysis system of claim 1, further comprising a gas separator tank coupled between the electrolyzer cell and the membrane degasser, wherein the gas separator tank is configured to receive the water solution output by the electrolyzer cell to remove at least a portion of the hydrogen gas therefrom.

10. The electrolysis system of claim 1, further comprising a pump, wherein the pump is operatively coupled between the water tank and the electrolyzer cell to direct water from the water tank to the electrolyzer cell.

11. A degassing device comprising:
a housing enclosing a tube therewithin, wherein the tube extends along a length of the housing and is operatively coupled to output a water solution including water and hydrogen gas, wherein the tube defines a plurality of openings configured to disperse at least a portion of the water solution through the tube and to collect at least a portion of the water solution within an interior of the housing; and
a plurality of membrane members extending interior to and along the length of the housing and parallel to the tube,
wherein the plurality of membrane members are disposed to surround the tube,
wherein each membrane member of the plurality of membrane members is operatively coupled to output a strip gas configured to separate the hydrogen gas within the water solution and remove a separated hydrogen gas from the tube through the plurality of openings to generate a degassed water in the tube.

12. The degassing device of claim 11, wherein the housing defines an inlet liquid port for receiving the water solution therethrough and an outlet liquid port for outputting the degassed water.

13. The degassing device of claim 12, wherein a first end of the tube is operatively coupled to the inlet liquid port and a second end of the tube opposite the first end is operatively coupled to the outlet liquid port.

14. The degassing device of claim 13, wherein the housing defines an inlet gas port for receiving the strip gas and an outlet gas port for outputting the strip gas and the separated hydrogen gas, wherein the inlet liquid port and the outlet gas port are disposed about a first end of the housing, and wherein the outlet liquid port and the inlet gas port are disposed about a second end of the housing opposite the first end of the housing.

15. The degassing device of claim 14, wherein a first end of each membrane member of the plurality of membrane members is coupled to the inlet gas port and a second end opposite the first end of each membrane member of the plurality of membrane members is coupled to the outlet gas port.

16. An electrolysis system comprising:
an electrolyzer cell configured to convert water into oxygen gas and hydrogen gas using electrolysis, wherein the electrolyzer cell outputs a water solution including water and a liquefied hydrogen gas; and
a membrane degasser operatively coupled downstream of the electrolyzer cell to receive the water solution therefrom,
wherein the water solution flows through an interior of the membrane degasser in a first direction and a strip gas flows through the interior of the membrane degasser in a second direction,
wherein the second direction is opposite the first direction such that the strip gas separates and removes the liquefied hydrogen gas from the water solution to generate a degassed water,
wherein the membrane degasser outputs the degassed water to a water tank for recirculation to the electrolyzer cell.

17. The electrolysis system of claim 16, wherein the membrane degasser includes a tube and a plurality of elongated membrane members extending parallel to and surrounding the tube, wherein the water solution flows in the first direction through the tube and the strip gas flows in the second direction through the plurality of elongated membrane members.

18. The electrolysis system of claim 17, further comprising a gas separator tank operatively coupled between the electrolyzer cell and the membrane degasser, wherein the gas separator tank is configured to receive the water solution output by the electrolyzer cell and remove at least a portion of the liquefied hydrogen gas from the water solution to generate a reduced gas water solution.

19. The electrolysis system of claim 18, wherein the reduced gas water solution includes less than 1 percent of liquefied hydrogen gas.

20. The electrolysis system of claim 16, further comprising a pump, wherein the pump is operatively coupled between the water tank and the electrolyzer cell to direct water from the water tank to the electrolyzer cell.
